(19) United States
(12) Patent Application Publication
(10) Pub. No.: US 2006/0177620 A1
(43) Pub. Date: Aug. 10, 2006

(54) Cloth covered instrument panel

(76) Inventors: John D. Gray, Union, NH (US); Bruce Batchelder, Dover, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/358,941

(22) Filed: Feb. 21, 2006

Related U.S. Application Data
(63) Continuation of application No. PCT/US04/27338, filed on Aug. 23, 2004.
(60) Provisional application No. 60/497,359, filed on Aug. 21, 2003.

(51) Int. Cl. B32B 3/00; B32B 37/00

(52) U.S. Cl. 428/57; 156/349

(57) ABSTRACT

An instrument panel for a vehicle comprising a first coverstock segment having an outer surface and an inner surface and a mating edge disposed along a portion of a common perimeter of the outer surface and inner surface. A second coverstock segment is supplied having an outer surface and inner surface and a mating edge disposed along a portion of a common perimeter bounding the outer surface and the inner surface, the second coverstock segment bonded to the first coverstock segment along the respective mating edges forming a joint line. At least one of the first coverstock segment and the second coverstock segment is a cloth or fabric.

### CROSS REFERENCE TO RELATED APPLICATIONS

This application is a continuation of International Application No. PCT/US2004/027338 filed Aug. 23, 2004 and published Mar. 10, 2005 as International Publication No. WO 2005/021309, designating the United States, and which claims benefit of U.S. Provisional Application No. 60/497,359 filed Aug. 21, 2003, the teachings of which are incorporated herein by reference.

This invention relates to trim covers for upholstery and trim panel applications, particularly for automotive applications and, more particularly, to an instrument panel for a vehicle wherein the outer surface is formed, at least in part, of a cloth or fabric. This invention further relates to forming a tear seam in a panel which comprises a plastic interface with either a cloth or a fabric.

### BACKGROUND OF THE INVENTION

Upholstery surfaces and adjacent panels in home and office environments as well as inside transportation vehicles are generally covered with a soft colored material to distinguish the surface from wood or metal and to provide a warm and pleasing appearance. These surfaces may comprise a trim cover which overlies a foam pad to provide a comfortable interface with humans. The materials used to form these trim covers, often referred to as “interior trim” in the transportation industry, vary widely from plush leather, to plastic skins of vinyl, urethane, olefins and alloys thereof, to woven or knitted cloth, velour, suede or carpet, and even hard plastic injection molded skins or shells. Recently, particularly in the automotive industry, there is an increased interest in providing cloth surfaces for instrument panels, in addition to door panels and headliners, to provide differentiation of the vehicle interior as well as to provide the potential for reduced cost. U.S. application Ser. No. 10/373,332, entitled “Preweakening of Fabric Covered Air Bag Doors” is directed at articles of this type and is commonly assigned to the assignee of the present invention and is included herein by reference.

The use of a cloth or fabric to form complex shapes such as instrument panels may involve manufacturing the trim cover by any of a number of processes including, but not limited to, vacuum forming “cut-and-sew” and “foam-in-place” and “shooting behind” a skin, for instance, by injection molding. A co-pending U.S. Provisional Application No. 60/486,851, entitled “Cast Cloth Texture Trim Cover” is directed at forming a cloth appearing trim cover by solidifying a plastic composition on a textured surface and is commonly assigned to the assignee of the present invention and is included herein by reference.

To further distinguish an instrument panel for the interior of a vehicle, it is desirable to manufacture the trim cover, or outer surface of the panel, of different colors, different materials and/or different textures to provide a unique appearance. While it is well known to use multiple materials to cover vertical trim panels, such as door panels, etc., due to the more complex shapes and weathering requirements for instrument panels, which are essentially horizontally disposed and exposed to heavy sunloads through the windshield, cloth covered instrument panels have not been available nor acceptable. Further, to provide an instrument panel having multiple colors, textures and/or materials, one of which is a cloth or fabric, is an even more complex task. Finally, to provide a tear seam for an air bag door in which the tear seam comprises a joint line between the main panel and the air bag door cover, and the main panel and air bag door cover are of different materials, one or more of which is a cloth or fabric, has heretofore not been accomplished.

Many of the methods used to join together dissimilar materials for door panels have relied on an infold to provide an acceptable joint line and hide the edges of the sheets of material so joined. This type of infold joint may not be acceptable for an instrument panel as a more uniform joint line having a small gap may be required for a panel directly in full and constant view of the occupants. Further, this type of joint may not provide the reliability of fracture required for an air bag door tear seam.

U.S. Pat. No. 4,861,543, entitled “Method for Thermoforming Multiple Coverstock and Slush Stock Having Finished Styling Lines Therein” is commonly assigned to the assignee of the present invention and included herein by reference. It is directed at a method of folding the edges of two polyvinyl chloride (PVC) sheets of different colors together and vacuum forming such into a door panel forming a finished styling line.

U.S. Pat. Nos. 5,705-005 and 5,773,115, entitled “Fabrication of Multiple Color, Gauge and Textured Interior Auto Components” are commonly assigned to the assignee of the present invention and included herein by reference. They are directed at a trim panel assembly, and method of making such, comprising first and second coverstock segments bonded along a mating edge to form a rough seam disposed along a common perimeter, first and second rigid substrate components bonded to said first and second coverstock and an infold formed along the rough seam and sandwiched between mating flanges of the rigid substrate components U.S. Pat. No. 5,538,581, entitled “Method for Electromagnetically Welding Thermoplastic Articles Together” is commonly assigned to the assignee of the present invention and included herein by reference. It is directed at depositing magnetic particles on a mold surface of a first plastic article while applying direct current to the coil of an electromagnet disposed beneath the first thermoplastic article, pressing a second thermoplastic article against the mold surface and applying an alternating current to the coil of the electromagnet while the second plastic article is pressed against the mold surface to join together two plastic materials.

There are a number of United States Patents assigned to Duotex Products Associates and entitled “Method of Forming Plastic Molded Panels with Inserts”. U.S. Pat. Nos. 5,091,031; 5,340,425; 5,411,688; 5,529,742 and 5,824,251 are directed at methods for forming trim panels, such as door panels, by forming a blank of a thin, flexible plastic sheet, positioning at least one separate shaped cover insert upon the sheet and bonding (dielectric) a narrow edge band portion along the peripheral edge, removing the portion of the blank which underlies the insert within the narrow edge band portion, positioning the blank and insert in a vacuum forming mold, folding the border strip into a U-channel in that mold, bonding a relatively thick plastic substrate (usually by injection of a plastic) to the inner surface of the blank and insert and removing the panel from the mold to provide a panel with the edge seams of the insert visually concealed.

U.S. Pat. No. 3,419,447 to Uniroyal, Inc. is entitled “Method and Apparatus for Bonding Together Two Thermoplastic Sheets by Ultrasonic Energy”. Claims are directed at overlapping two thermoplastic sheets, subjecting them to compression and vibration in a specific frequency range and cutting through the sheets to form a butt joint.

U.S. Pat. No. 4,364,785 to Wajs, et al, entitled “Association of a Piece of Fabric with a Sheet of PVC”, claim 1 is directed at placing a sheet of plastic material over a sheet of fabric material, welding along two weld lines, cutting the plastic sheet between the weld lines and removing the portion of the plastic sheet that lies between the weld lines.

U.S. Pat. No. 4,810,452 to Automobiles Peugeot, entitled “Method of Making a Facing Panel” is directed at placing (held by vacuum) several fragments of ornamental material of differing natures or colors against a wall of a die, backfilling by spraying with polyurethane (possibly of various colors) and applying a backing of thermoplastic or compressed wood fibers.

U.S. Pat. No. 4,829,644 to Nissan Motor Co., entitled “Method of Molding Skin Covered Foam Plastic Article” is directed at preparing a bag shaped skin member consisting of two portions stitched together, placing the member in a mold having a groove around its periphery and foaming the member in place.

U.S. Pat. No. 4,978,407 to Polistock N V, entitled “Method for Forming Laminated Panels Having Folds” is directed at a cover layer of two differing segments which has the seam line between the segments pressed into an elongated groove in a substrate layer by a protrusion in a forming die.

U.S. Pat. No. 5,304,273 to G.M., entitled “Method for Manufacturing of Two-Tone Vehicle Trim Panel” is directed at (dielectric) bonding of two shaped flexible sheets, edge to edge, draping the sheets over a mold having a blade projecting from the surface, installing retainer means to hold the sheet to the blade, laying a sheet of glass fiber in the mold and pouring urethane in place.

U.S. Pat. No. 5,348,604 to Craig Neff, entitled “Method and Apparatus for Applying a Heated Composition to a Substrate” is directed at the application of a heat activatable polymer composition to form surface or butt welds of two substrate sheets by using an energy beam (laser) to heat the adhesive bead and substrate.

U.S. Pat. No. 5,509,990 to Sumitomo Chemical Co., entitled “Process for Producing a Multilayer Molded Article” is directed at clamping mated edge parts of two sheets of skin material, inserting the clamped edge into an engaging groove in a mold and injection molding behind said skin.

U.S. Pat. No. 5,919,324 to UT Automotive Dearborn, Inc., entitled “Method of Securing Decorative Insert to Underlying Plastic Skin for Trim Panel” is directed at a method of securing (with adhesive) a cloth insert to a (vinyl) skin in a vacuum mold and subsequently injecting a polymer behind the skin in a polymer mold. A tuck blade in the polymer mold surrounds the periphery of the cloth insert to form a seam.

U.S. Pat. No. 5,951,802 to Marley Automotive Components, Ltd., entitled “Vehicle Trim Panel” is directed at a method of making a vehicle trim panel comprising bonding (adhesive welding) a first interior lining (woven fabric) material to a polyethylene or polypropylene preformable foam sheet to form a blank, preforming the blank into a contoured shape, joining (welding) the preformed blank to a second interior lining material (PVC) and then bonding both the preformed blank and second lining material to a substrate.

U.S. Pat. No. 6,093,272 to G.M., entitled “Method for Making Trim Panel Having Two Different Trim Materials”, is directed at providing first and second sheets of flexible material, cutting the first material and draping it over a mold having a blade projecting at a junction for the two sheet materials, forming a composite product of a rigid substrate material and the second sheet material, installing the composite product onto the mold and snapping it over the blade draped with the first sheet material and adhering (injecting) a suitable molding material to the first and second sheets.

U.S. Pat. No. 6,521,067 to Rosslyn Precision, Ltd., entitled “Ultrasonic Seam Bonding Method and Apparatus” is directed at a method of joining separate pieces of layered fabric via a hot melt adhesive and ultrasonic energy. The edge of the layers are aligned in an end to end relationship.

PCT 0175210 to Rosslyn Precision, Ltd., entitled “Fabric Joining by Fiber Encapsulation” is directed at joining first and second fabric sheets by applying a molten adhesive to the fabric and impregnating the fibers by a combination of a roller and heat from an infrared source or an ultrasound head.

JP 04153360 to Tokiwa Shoji KK, entitled “Method and Apparatus for Connecting Fabric” is directed at forming a butt joint between fabric ends by super-imposing a fusion tape made of a heat-fusible material so as to straddle the butted joint. Ultrasonic vibrators and an anvil join the fabrics.

EP 0997261 to Leister Process Technologies, entitled “Laser Welding Method and Apparatus for Joining a Plurality of Plastic Articles with Each Other or with Other Materials” is directed at a laser joining method for joining work pieces made of plastic or joining plastic to other materials where the top work piece is made of a material transparent to the laser beam and the bottom work piece is made of a material that will absorb the laser beam. A mask is arranged so that the laser is directed at the contact surface and either the laser or mask moved to form a line.

While all of these references deal with joining sheets of material together, they do not address the need to provide a high quality joint line having a consistent but minimal gap and having a definable tear strength, using cloth materials for an instrument panel application.

### SUMMARY OF THE INVENTION

In a first embodiment, the present invention is directed at providing an instrument panel for a vehicle including a trim cover, or outer surface, comprising materials of multiple colors, different textures and/or different compositions, one of which is cloth or fabric.

In a second embodiment, the present invention is directed at a method of forming a joint line having a consistent but minimal gap between the materials of multiple colors, textures and/or compositions for use as a trim cover for an instrument panel.

In a third embodiment, the present invention is directed at providing a joint line between materials of multiple colors, textures and/or compositions suitable for use as a tear seam for an integral air bag door.

It is an object of the present invention to provide an instrument panel for a vehicle wherein multiple materials of different colors, different textures and/or different compositions, are used, at least one of which is a fabric.

It is a further object of the present invention to provide novel processes for joining these multiple materials together to form a high quality, aesthetically pleasing joint line having a consistent but minimal gap between adjoining surfaces.

It is further object of the present invention to provide a joint line between these different materials which has a definable tear strength useful as a tear seam for an air bag door application in a trim panel.

It is a still further object of the present invention to provide a trim cover for an instrument panel wherein different sections of the panel, such as the upper, lower, air bag door cover, console area and cluster, may have a different appearance from the remainder of the panel by joining that section with a different color, material and/or texture from that of the main panel. Thus, and instrument panel may be produced having a cloth outer surface (or trim cover) with either a cloth or plastic air bag door cover joined as taught in this invention. Conversely, the main instrument panel may be formed of plastic, say a vinyl, urethane or olefin skin and have a cloth air bag door cover joined as taught herein.

These and other features, objects and advantages will be apparent from the following description and accompanying drawings of the preferred embodiments of the present invention.

### BRIEF DESCRIPTION OF THE DRAWINGS

FIG. 1 is a perspective view of an instrument panel and integral air bag door of the first embodiment of the present invention.

FIG. 2 is a perspective view of an instrument panel and integral air bag door a second embodiment of the present invention.

FIG. 3 is a perspective view of an instrument panel and integral air bag door a third embodiment of the present invention.

### DETAILED DESCRIPTION OF THE PREFERRED EMBODIMENTS

For elements common to various embodiments of the present invention, the numeral reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished by alphanumeric character, to the other embodiments where the element is common.

As noted above, the present invention is directed at forming a trim cover for, preferably, an instrument panel in a vehicle wherein the trim cover comprises multiple colors, different textures and/or different compositions, wherein at least one of the colors, textures and/or compositions is a fabric or cloth.

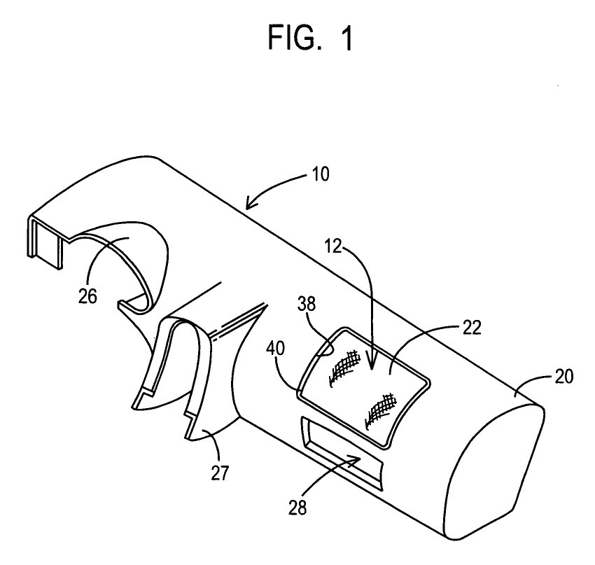

An instrument panel assembly for a motor vehicle is generally shown at 10 in FIG. 1. The instrument panel assembly 10 includes an integral air bag door 12, a driver's side instrument cluster 26, a center console area 27 and glove box 28. The instrument panel assembly includes a first surface trim cover 20 which overlies, preferably, a foam layer and rigid substrate (both not shown). The instrument panel trim cover 20 provides an aesthetically pleasing outer surface for the instrument panel assembly 10 and is preferably a thin flexible plastic skin having a grained or leather-like texture, formed by methods well known to those skilled in the art, including but not limited to, casting, vacuum forming, injection molding, blow molding, slush molding, spraying, etc. An air bag door is shown at 12 which has a cover 22 comprising a cloth or fabric which distinguishes the air bag door trim cover 22 from the instrument panel trim cover 20. The cloth or fabric trim cover 22 of the air bag door has an outer peripheral edge 40 that is attached to an inner peripheral edge 38 of an opening in the instrument panel assembly 10 by methods to be described later. The instrument panel assembly 10 as shown in FIG. 1 provides a distinctive appearance with the contrasting trim cover surfaces of flexible plastic 20 and cloth or fabric 22.

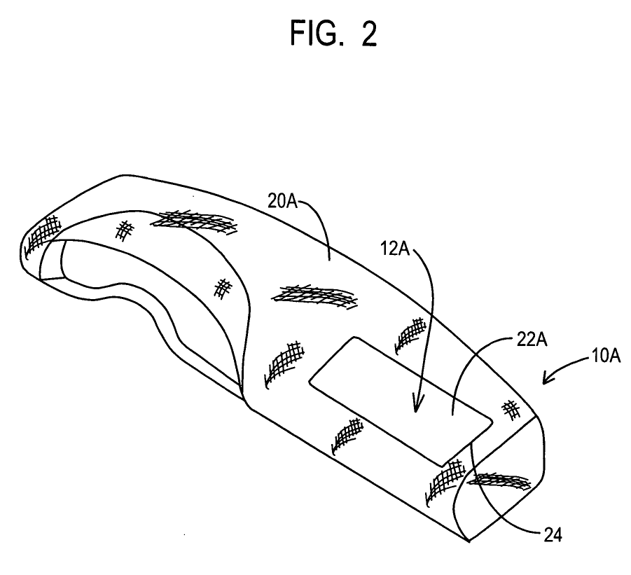

FIG. 2 illustrates an alternate construction for an instrument panel 10A for a vehicle wherein the air bag door cover 12A comprises, preferably, a thin flexible plastic outer shell 22A having a grained or embossed decorative surface and the surrounding trim cover 20A for the remainder of the panel comprises a cloth or fabric (shown as cross-hatched lines). Again, a distinctive appearance option may be offered by the vehicle manufacturer using this invention. The cloth or fabric trim cover 20A in FIG. 2 may be formed to shape by any of the number of methods known to those skilled in the art, including but not limited to, vacuum forming, pressure forming, “foam-in-place”, “cut-and-sew”, “shoot behind” using a process such as injected molding, etc. As further shown in FIG. 2, it is an objective of the invention to form a joint line 24 along which the cloth and plastic trim covers are attached, which is both aesthetically pleasing and functional.

For an instrument panel, where it is in full and constant view of the vehicle occupants at all times, the joint line preferably has a narrow or minimal but consistent gap between each of the attached surfaces, 38 and 40 in FIG. 1, formed to nearly equal radii as they depend from the top surfaces 20, 20A, 22, 22A of the trim covers. Additionally, the joint line 24 should preferably have a consistent sweep that flows with adjacent lines and design features of the instrument panel and preferably does not include sharp corners.

Regarding functionality, the joint line 24, formed by attachment of surfaces 38 and 40 (see FIG. 1) may provide a tear seam for an air bag door as shown at 24 in FIG. 2. The joint line may be formed to have a tear seam preferably having a predictable bond strength so that the opening of the air bag door by the deploying air bag causes the tear seam to fracture along the joint line when the door opens. In a most preferred embodiment the tear strength of the bond line of the preferably flexible plastic and cloth or fabric trim covers is between 25% and 50% of the tear strength of the weaker of the flexible plastic or cloth or fabric trim cover. This allows for a controlled and clean deployment of the air bag with minimal or no fragmentation.

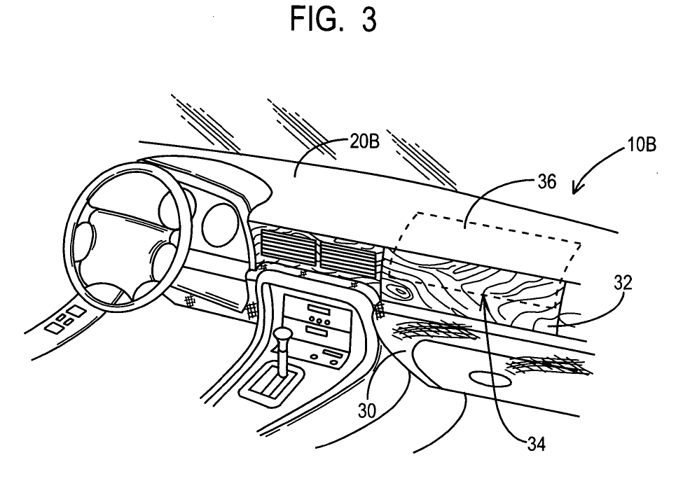

In an alternate construction, as shown in FIG. 3, the instrument panel assembly 10B may include an invisible or hidden air bag door 36, shown by dashed lines, that underlies an upper trim cover 20B. The upper trim cover 20B may be either of flexible plastic or cloth construction (for instance, flexible plastic as shown in FIG. 3). The lower section of the instrument panel assembly 10B may include a lower trim cover 30 (shown by cross-hatched lines), which may be either of flexible plastic or cloth to coordinate with yet remain distinguished from the upper trim cover 20B having the preferably opposite construction (for instance, cloth as shown in FIG. 3). In the instrument panel assembly 10B shown in FIG. 3, the joint line between the two trim cover materials, 20B and 30, is hidden by an applique 32. This applique 32 may be of a decorative nature but is preferably of simulated wood grain. Use of an applique to cover an air bag seam as described herein is the subject of U.S. Pat. Nos. 5,901,977; 5,992,876 and 5,806,880, commonly assigned to the assignee of the present invention and included herein by reference.

The combination of cloth and plastic trim covers for portions of an instrument panel assembly, as described above, may include the use of complimentary or contrasting colors and may take advantage of the light stability of one material for the majority of the upper surface of an instrument panel and a poorer weathering perhaps less expensive material for the lower surfaces not as heavily exposed to sunlight.

Regarding joining methods for affixing cloth or fabric and a plastic shell to form a trim cover, it is preferred that a method is used which melts one of the materials into the other yielding a smooth consistent point line. In one preferred embodiment, a trim cover for an instrument panel, as shown in FIG. 1 is slush molded of a polyvinyl chloride microsphere composition with an opening formed with a finished interior edge (38 in FIG. 1) for an air bag cover. A polyester woven fabric is cut to be slightly larger than the opening in the PVC slush molded trim cover and is affixed to the underside of the PVC trim cover using hot plate welding to melt the PVC into the texture of the polyester fabric forming a bond and resulting in a trim cover having a finished trim line surrounding the air bag door trim cover.

An alternate method of joining involves heat staking of the fabric and cast plastic material together wherein the plastic shell is formed with ribs or upsets on the surface to be joined. Upon contacting the mating fabric surface to the plastic surface containing the upsets, a heating device is applied to melt the upsets into the fabric. In this manner, the adhesive strength of the bond can be controlled by the size and amount of upsets that provide intimate contact and melting between the two materials.

An alternate method of mechanically joining two sheets of different materials of the present invention is disclosed in a co-pending application, PCT/US03/00424, entitled “Joint Assembly For A Trim Panel” commonly assigned to the assignee of the current invention and included herein by reference. In this embodiment, each of the two sheets of different color, texture and/or composition have a series of holes formed along the edges which are to be adjoined. A connector platform is provided which has two rows of pins arranged along it's length, the pins sized and spaced so as to engage with the two sheets of material to join them together. The connector platform may be visible along the outer surface of the trim panel or may form the base of a groove which may be covered by an appliqué'.

It should be apparent from the above written description and FIGS. that an instrument panel for a vehicle having a distinct appearance may be formed by joining together two materials one of which is a cloth or fabric. Further, the joint line formed by the joining of the two materials is distinguished by having an appearance which includes a consistent radius on both sides with minimal gap and a smooth sweeping contour. Finally, the joint line may be used as a tear seam for the air bag door which comprises a portion of the instrument panel, the tear seam having a defined range of tear strength to allow controlled deployment of the air bag.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

What is claimed is:

1. An instrument panel for a vehicle, said instrument panel including an outer trim cover comprising two or more materials, whereby at least one of the two or more materials comprises a cloth or fabric.

2. An instrument panel for a vehicle comprising:
a first coverstock segment having an outer surface and an inner surface and a mating edge disposed along a portion of a common perimeter of said outer surface and inner surface;
a second coverstock segment having an outer surface and inner surface and a mating edge disposed along a portion of a common perimeter bounding said outer surface and said inner surface, said second coverstock segment bonded to said first coverstock segment along said respective mating edges forming a joint line, wherein at least one of said first coverstock segment and said second coverstock segment is a cloth or fabric.

3. The instrument panel of claim 2, wherein one of said first and said second coverstock segment is a plastic skin formed by slush molding.

4. The instrument panel of claim 2, wherein one of said first and said second coverstock segment is a plastic skin formed by spraying.

5. The instrument panel of claim 2, wherein one of said first and said second coverstock segment is a vacuum-formable sheetstock composition.

6. An instrument panel for a vehicle, said instrument panel including an outer cover comprising at least two different plastic materials, joined together to form at least one joint line, wherein at least one of the at least two different materials is a cloth or fabric.

7. The instrument panel of claim 6, wherein each of said at least two different materials includes an edge wherein said at least two different plastic materials are joined along said edge to form a joint line.

8. The instrument panel of claim 7, wherein said joint line is a tear seam for an air bag door.

9. The joint line of claim 8, wherein said tear seam has a tear strength between about 25% to about 50% of the tear strength of the weaker of the at least two different plastic materials.

10. The joint line of claim 8, wherein said joint line is covered with an applique.

11. A method for forming a joint line in an instrument panel for a vehicle, said instrument panel including an outer trim cover comprising two or more materials, whereby at least one of the two or more materials comprises a cloth or fabric, wherein said joint line is formed by melting one of said two or more materials to melt bond said materials and form said joint line.

12. The method of claim 11 wherein said melting is via hot plate welding.

13. The method of claim 11 wherein one of said two or more materials includes a surface with a projection and said melting is via heat staking said projection to the other of said two or more materials.
